(19) United States
(12) Patent Application Publication
(10) Pub. No.: US 2007/0037109 A1
(43) Pub. Date: Feb. 15, 2007

(54) Self-cooled high-temperature fan apparatus

(76) Inventor: Erik A. Lange, Jackson, WI (US)

Correspondence Address: JANSSON, SHUPE, MUNGER & ANTARAMIAN, LTD, 245 MAIN STREET, RACINE, WI, 53403, US

(21) Appl. No.: 11/191,630

(22) Filed: Jul. 28, 2005

(51) Int. Cl. F27D 1/08

(52) U.S. Cl. 432/96

(57) ABSTRACT

A self-cooled high-temperature fan apparatus for use in displacing high-temperature gases and atmospheres, such as the atmosphere within a high-temperature furnace. The preferred fan includes a frame supporting the fan. One or more bearings rotatably support a fan shaft. A fan element is supported by the fan shaft. Heat transfer through the fan and fan shaft is limited by an air-flow passageway and ports provided in the fan shaft and induction apparatus for inducing air flow through the passageway and ports as the fan shaft rotates. The fan apparatus is configured to limit heat transfer through the fan apparatus without the need for separate fan-cooling apparatus thereby preventing bearing damage and generally increasing the fan's operational life.

### FIELD

The field relates to displacement apparatus and, more specifically, to high-temperature fan apparatus.

### BACKGROUND

High-temperature furnaces and ovens are commonly employed in industry for use in heat treating of metal parts and products. Such furnaces are commercially available from sources such as Ipsen, Inc. of Rockford, Ill., Surface Combustion of Bowling Green, Ohio and AFC-Holcroft of Wixom, Mich. These high-temperature furnaces typically consist of a furnace chamber defined by top, side and bottom walls. The furnace walls typically have a thickness (i.e., a dimension between wall outer and inner surfaces) on the order of about 8 to 12 inches. One or more doors are provided in the furnace walls for purposes of moving the parts and products into and out of the furnace chamber.

The furnace chamber is typically heated by use of gas-fired burners positioned along the furnace top and/or bottom walls. Heated air or other gas is directed from the burners into one or more heating elements positioned through the furnace top and/or bottom walls and within the furnace chamber. Heat transfer from the elements to the furnace chamber heats the chamber to the desired temperature. A typical temperature range to which the chamber is heated is in the range of between about 1000° F. to about 1850° F. Gas burners for use in heating high-temperature furnaces may include, for example, single ended recuperative burners available from Eclipse Combustion, Inc. of Rockford, Ill.

Heat treating of metal parts and products within the furnace is an exacting and demanding process. In order to uniformly heat treat parts within the furnace the operator must carefully control conditions within the furnace. To this end, it is essential that a uniform temperature be maintained within the furnace and that thermal gradients be avoided. Gases such as nitrogen and hydrogen are frequently introduced into the furnace chamber in order to impart particular properties to the parts and metal products. Such gases, and the atmosphere generally, must be uniformly distributed within the furnace chamber. The furnace and its components must be designed to withstand the elevated furnace temperatures as well as the corrosive environment created by the gases and materials within the furnace.

Fans, such as “plug fans,” have been developed in an effort to provide a uniform temperature within the furnace and to evenly distribute the furnace atmosphere. A plug fan typically consists of a frame which is inserted, or plugged, into an opening in the furnace top wall. Fan blades mounted on a fan shaft extend from the frame into the furnace chamber. The fan shaft is rotatably mounted on one or more bearings located within the frame or outside of the furnace. A motor coupled to the fan shaft rotates the shaft so as to rotate the fan blades within the furnace chamber. Rotation of the fan blades within the furnace chamber displaces the furnace atmosphere and uniformly distributes the temperature and gases within the furnace chamber. Commercial sources of plug fans include Alloy Engineering Co. of Berea, Ohio and Industrial Gas Engineering Co., Inc. of Westmont, Ill.

A major engineering challenge affecting plug fans used in connection with high-temperature furnaces is that the harsh operating environment and high temperatures of such furnaces rapidly damage the fan thereby shortening the fan's useful life. Thermodynamic heat transfer in the form of conduction, radiation and convection all act to damage the fan. For example, heat from within the furnace chamber is conducted through the fan and fan shaft into the bearings supporting the fan shaft. Radiant and convection heat can be transferred along the outer surface of the fan shaft or through the fan frame to the bearings, fan motor and other fan components. Such heat transfer causes the bearings and other fan components to fail requiring replacement or extensive repair of the fan. Standard bearings are particularly susceptible to failure at temperatures of approximately 300° F. at which point typical lubricants fail resulting in bearing failure and damage to the fan. Direct costs are incurred to replace or repair the fan and indirect costs are incurred based on the operator's inability to operate the furnace.

In an effort to limit heat and funace-related fan damage and extend the useful life of the fan, certain fans have been equipped with separate, active cooling systems. Such active cooling systems are provided to remove heat from the fan shaft and fan frame thereby limiting heat transfer into, and failure of, the bearings and other components. For example, certain plug fans are provided with a water-cooled frame. Chilled water is piped under pressure through the frame in order to remove heat from the fan. Other plug fans utilize compressed air cooling systems in which heat is removed from the fan by passing a stream of compressed air in proximity to the fan.

Such active cooling apparatus disadvantageously adds unnecessary cost to the fan both in terms of the cooling apparatus and in terms of the cost to operate such apparatus. The cooling apparatus may be subject to failure, for example, if impurities within the coolant supply line limit the flow of coolant to the bearings. And, inclusion of such active cooling apparatus with the fan adds a further maintenance item with respect to operation of the furnace.

Applicant's U.S. Pat. No. 6,454,530 describes fans which can be used in high-temperature environments without a requirement for an active cooling system. These fans utilize certain openings in the fan shaft which facilitate heat control. While these fans operate very reliably, further improvement is possible.

Applications, other than heat treating operations, may have high-temperature environments which require apparatus to displace gases within said environments. For example, Lamington Curing Furnaces can include high-temperature environments which require uniform temperatures. The foregoing problems with respect to the fan apparatus used in heat treating furnaces can also affect these other applications. The apparatus selected for use in displacing high-temperature gases must be resistant to damage from the elevated temperatures yet at the same time be durable and economical to operate.

An improved fan for use in high-temperature environments which would facilitate displacement of the atmosphere within such environments resulting in more uniform temperatures and gas distribution and which would be self-cooling in that no separate active cooling apparatus would be required to enable operation in high-temperature environments would represent an advance in the art.

### SUMMARY

Self-cooled high-temperature fan apparatus are shown and described herein. Fan embodiments are particularly useful in circulating high-temperature gas, for example within the chamber of a heat treating furnace used to heat treat metal parts. Fan apparatus are capable of extended operation in high-temperature environments without a requirement for external cooling apparatus, such as water or air-cooling apparatus.

In general, preferred fan embodiments comprise a frame, a fan shaft, an induction apparatus and a fan element. The fan shaft has first and second ends and an axis between the ends. It is preferred that the fan shaft is rotatably supported and secured with respect to the frame by a bearing which is a rotary support. Most preferably, plural axially aligned bearings secure the fan shaft with respect to the frame. In preferred embodiments, a motor is mounted with respect to the frame to power rotation of the fan shaft.

Preferred forms of the fan shaft include an air-flow passageway and ports in communication with the passageway. At least a portion of the air-flow passageway extends within the fan shaft along the axis proximate the bearing. The passageway and ports function much like ducting providing a passageway for air to circulate through the fan shaft along at least parts of its length. Movement of air along the fan shaft portion near the bearing or bearings facilitates limitation of heat transfer into the bearing or bearings. Air flow through the passageway is induced by induction apparatus preferably mounted on the fan shaft proximate at least one of the ports. Co-rotation of the fan shaft and induction apparatus induces air to flow through the passageway. The induced air removes heat and cools the fan shaft during operation extending the bearing life and the service life of other fan components. Optionally, additional openings or voids may be provided in the fan shaft to further limit heat transfer through the fan shaft.

Preferred fan elements are utilized to directly or indirectly displace gas or gases within the chamber or other environment. Preferred forms of exemplary fan elements may include radial fans, axial fans and centrifugal fans.

In certain preferred embodiments, thermal barrier material may optionally be associated with the fan to limit heat transfer into the fan and its components.

### BRIEF DESCRIPTION OF THE DRAWINGS

The foregoing and other objects, features and advantages of the invention will be apparent from the following more particular description of preferred embodiments, as illustrated in the accompanying drawings in which like reference characters refer to the same parts throughout the different views. The drawings are not necessarily to scale, emphasis instead being placed upon illustrating the principles of the invention.

FIG. 1 is a perspective view of an exemplary fan apparatus.

FIG. 2 is an exploded view of the apparatus of FIG. 1.

FIG. 3 is a side elevation view of the fan apparatus of FIG. 1 but taken along section 3-3 of FIG. 9.

FIG. 4 is an enlarged view taken along section 4-4 of FIG. 3.

FIG. 5 is a section view taken along section 5-5 of FIG. 4.

FIG. 6 is a section view taken along section 6-6 of FIG. 4.

FIG. 7 is a section view taken along section 7-7 of FIG. 4

FIG. 8 is a section view taken along section 8-8 of FIG. 4

FIG. 9 is a schematic illustration of a high-temperature chamber, such as in a heat treating furnace.

### DETAILED DESCRIPTION

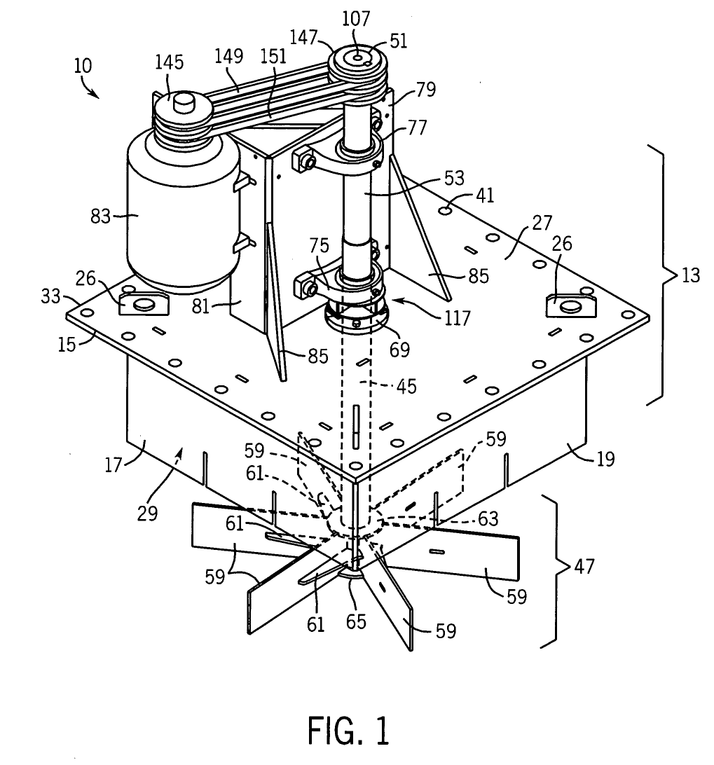

Embodiments of fan 10 will now be described with respect to FIGS. 1-9. Fan 10 will be described for use in an exemplary heat treating furnace 11 although fan 10 may be utilized in many other applications.

As is known, a heat treating furnace 11 may be used to strengthen and impart beneficial properties to metal parts and products. The environments within the chamber or chamber 39 of such furnaces 11 are typically in the range of about 1000° F. to 1850° F. but can exceed temperatures of about 2200° F. Such environments may also include corrosive gases. Fan 10 is adapted for use in such harsh environments and includes structure which prevents damage to bearings 75, 77 and other fan components caused by exposure to such conditions. And, fan 10 is adapted for operation in such environments without the requirement for an active cooling system. Such active cooling systems provide cooling by means of water or oil circulation or by flow of compressed air or gas about the fan. While such active cooling systems are not required, such systems could be used in combination with fans of the type as described herein.

Referring first to FIGS. 1-3, fan 10 includes a fan frame 13. A preferred frame 13 includes support member 15 and side walls 17, 19 and 21. A fourth sidewall is located behind wall 19 and is a mirror image of wall 19. Frame 13 further includes the related motor and bearing mount structure (79, 81) described herein.

Support member 15 is preferably substantially flat having surfaces 25, 27. Side walls 17-21 extend outwardly from surface 25 and are secured to support member 15, preferably by welding. Adjacent walls 17-21 are preferably welded along abutting edges thereby forming a cavity 29 for receiving and securing thermal barrier material 31 with respect to frame 13 as discussed in greater detail below. Eyelets 26 may be provided to secure chains or cables to fan 10 for purposes of moving fan 10. Support member 15 and walls 17-21 are preferably made of carbon steel plate.

In other fan embodiments, thermal barrier material 31 may optionally be omitted. Examples of such embodiments include static mount fans. Frame 13 may be modified accordingly, for example to omit walls 17-21 (and the fourth sidewall).

Mounting flange 33 is provided to secure fan 10 with respect to wall 35, for example of furnace 11. Furnace 11 wall 35 defines an opening 37 for receiving frame 13 and further defines a chamber 39 of furnace 11. A bolt 43, stud or other fastener may be extended through openings (e.g., opening 41) to secure support member 15 to wall 35. In the example shown, support member 15, side walls 17-21 (and the fourth sidewall) and flange 33 may be sized and arranged as required to position fan 10 tightly in wall 35 opening 37 so as to prevent heat and gas transfer out of furnace chamber 39.

Referring now to FIGS. 1-7, fan shaft 45 is provided to support fan element 47 through a wall opening (such as opening 37) and within chamber 39. Fan shaft 45 includes first and second ends 49, 51 and an outer surface 53. The material used in the manufacture of fan shaft 45 will vary depending on the temperatures to which fan 10 will be exposed. Number 330 stainless steel is one material satisfactory for use in manufacture of fan shaft 45. For higher temperature applications, for example in the range of between about 1200° F. to about 1800° F., nickel alloys may be used. Suitable nickel alloys include Number 304, 310, 600 or 333 nickel alloys.

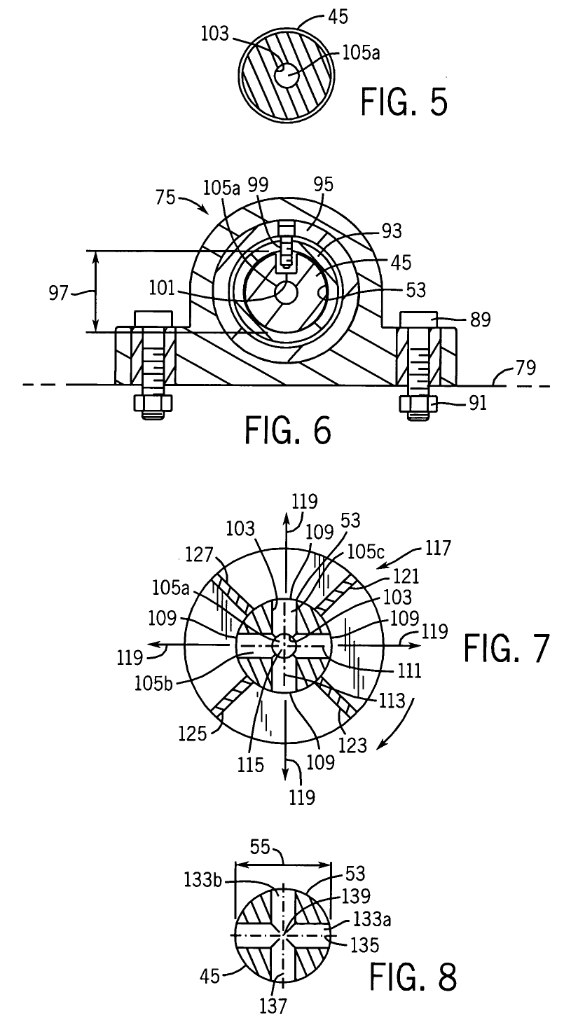

Fan shaft 45 is preferably circular in cross section, such as shown the sections of FIGS. 5-8. A preferred fan shaft diameter 55 is approximately two inches, although other shaft diameter dimensions may be appropriate given the particular application. In the example shown, fan shaft 45 has an axis 57 between ends 49, 51 and fan shaft 45 is of sufficient axial length so that fan element 47 may be positioned within chamber 39 and in contact with the gases comprising the atmosphere within chamber 39.

Fan element 47 is provided along shaft first end 49. Fan element 47 preferably comprises a radial fan including blades 59 extending radially outward from fan shaft 45. Number 330 stainless steel is a preferred material for use in the manufacture of blades 59. Other materials, such as the Number 304, 310, 600 or 333 nickel alloys described with respect to the fan shaft 45 may be used.

Referring to FIGS. 1-3, each blade 59 is preferably welded proximate fan shaft first end 49. Gussets 61 may be welded to fan shaft 49 and adjacent fan blades 59 in order to further support such fan blades 59. Top and bottom support rings 63, 65 may be welded to blades 59 to further reinforce fan element 47.

The surfaces of fan element 47 and those portions of fan shaft 45 within chamber 39 may optionally be coated with a coating (not shown) such as Cetek—720 coating available from Cetek of Transfer, Pa. Such a coating has low gas permeability and prevents chemical degradation of the base material used to manufacture the fan element 47 and fan shaft 45. Cetek—720 coating is useful in preventing carburization of nickel-containing alloys which can occur in high-temperature environments. The Cetek coating is applied as a liquid in a sufficient amount to have a thickness, when dried, of approximately 0.001 to 0.004 inches.

Fan element 47 is not limited to a radial fan having six blades 59 as shown in FIGS. 1-3 as any number of appropriate blades could be used. Moreover, other types of fan elements 47, such as a centrifugal fan or an axial fan, could be used consistent with fan apparatus 10.

Referring now to FIGS. 1-4, fan shaft 45 is positioned through annular opening 67 provided in support member 15. Opening 67 preferably has a diameter which is slightly greater than fan shaft diameter 55 providing a partial barrier against heat transfer through fan 10 along fan shaft 45.

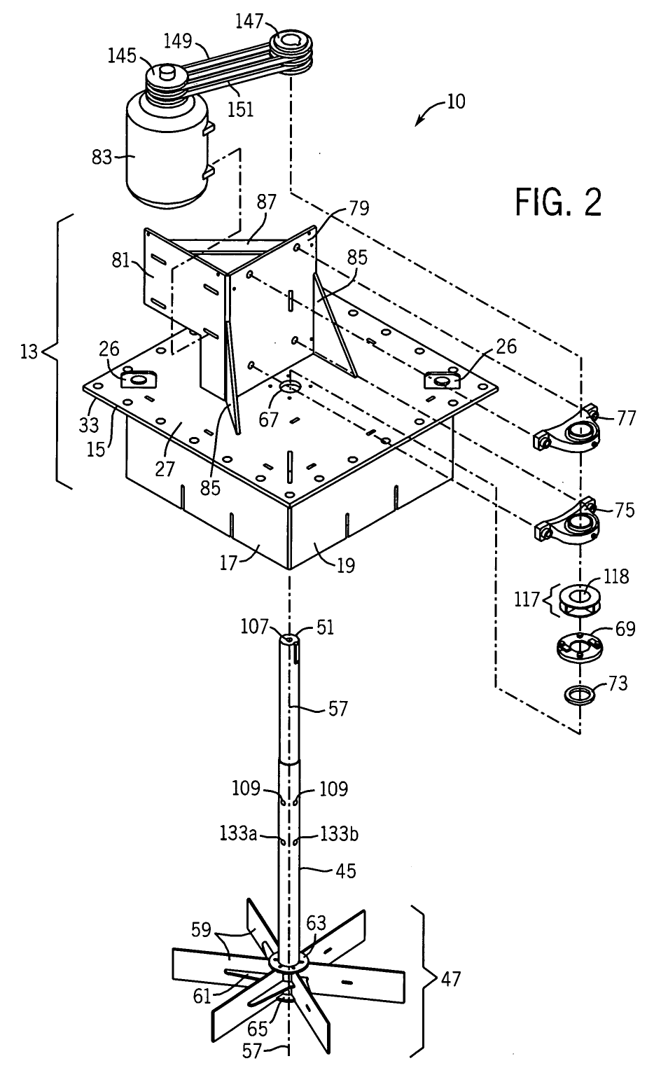

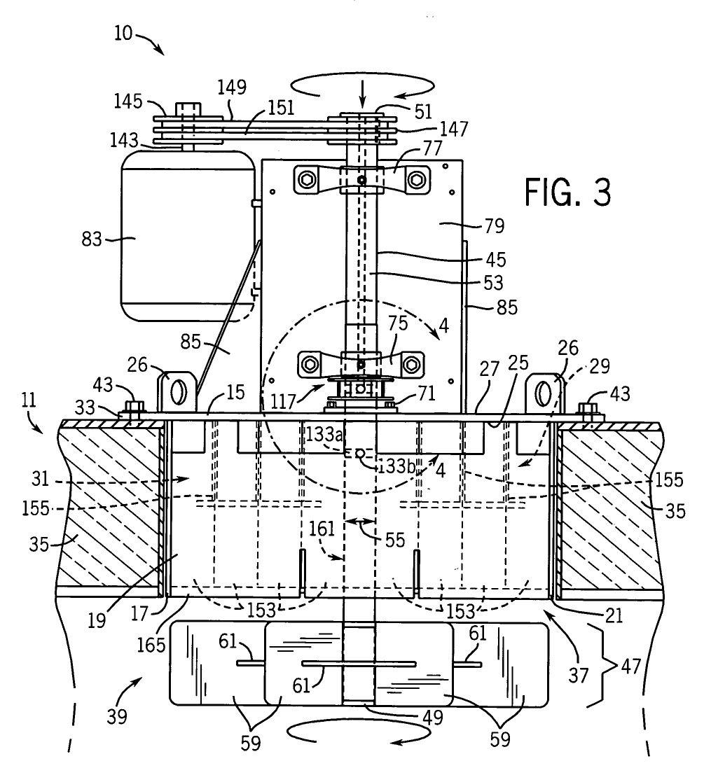

As is well-shown in FIGS. 2 and 3, it is preferred that a compression seal is provided along support member 15 surface 27 and along fan shaft outer surface 53 to further limit convective and radiant heat transfer through fan 10 along fan shaft 45. The compression seal preferably comprises an annular ring 69 made of steel or the like secured to support member 15 surface 27 by bolts (e.g., bolt 71) and high-temperature-resistant packing material 73 positioned between ring 69 and surface 27. Carbon weave rope or graphite teflon rope are preferred materials for use as packing material 73. Carbon weave rope has a temperature rating of about 1200° F. while graphite teflon rope has a temperature rating of about 550° F. Packing material 73 is positioned to directly abut the circumference of fan shaft outer surface 53 positioned through the preferred compression seal. Other types of seals known to those of skill in the art may be utilized.

Referring again to the preferred embodiment of FIGS. 1-4, fan shaft 45 is rotatably supported by bearings 75, 77. As shown in FIGS. 1-4, pillow block bearings 75, 77 are preferred. However, other types of bearings and rotatable supports known to those of skill in the art may be utilized.

Frame 13 preferably includes bearing mount 79 to which bearings 75, 77 are secured and a motor mount 81 to which motor 83 is secured. Bearing mount 79 and motor mount 81 are preferably welded to support member 15 surface 27. Gussets 85 may be welded to support member 15 and bearing mount 79. Brace 87 may be welded to bearing and motor mounts 79, 81 to provide further support for frame 13. Carbon steel plate is a suitable material for use in manufacture of bearing and motor mounts 79, 81, gussets 85 and brace 87.

Referring to FIGS. 1-4 and 6, bearings 75, 77 may be bolted to bearing mount 79 as represented by bolt 89 and nut 91. Bearings 75, 77 are mounted along bearing mount 79 such that they are axially aligned. Fan shaft 45 is rotatably supported by bearings 75, 79.

Referring further to FIG. 6 bearing 75 (and bearing 77) may be specially configured to limit heat transfer from fan shaft 45 and into bearing 75 and to accommodate thermal expansion of fan shaft 45 during operation in elevated temperatures. In such embodiments, bearing 75 includes annular inner and outer races 93, 95 and ball bearings (not shown) positioned between the inner and outer races 93, 95. Inner race 93 has an inside diameter 97 which is slightly larger than fan shaft diameter 55 when the fan shaft is cool. For example, diameter 97 may exceed diameter 55 by approximately 0.001 to approximately 0.003 inches. Pin 99 is tapped into and projects radially inwardly from inner race 93. Fan shaft 45 outer surface 53 includes slot 101 provided to mate with pin 99 when fan shaft 45 is journaled in bearing 75 causing inner race 93 to co-rotate with fan shaft 45.

This arrangement positions shaft outer surface 53 along less than the entire circumference of inner race 93. As a result, there is less than complete surface-to-surface contact between fan shaft 45 and bearing 75 thereby limiting potential conductive heat transfer from fan shaft 45 into bearing 75 and discharging heat into the ambient air thereby prolonging the useful life of bearing 75. The slightly oversized inner race 93, slot 99 and pin 101 arrangement further permits thermal expansion of fan shaft 45 without placing undue stress on bearing 75, again prolonging the useful life of bearing 75. Bearing 77 and shaft 45 may have the same structure as described with respect to bearing 75 and shaft 45.

Alternatively, an expansion bearing may be used for one or both of bearings 75, 77. A commercially available expansion bearing is a model UCEP 210-31 bearing available from AMI Bearings, Inc. of Mount Prospect, Ill. Depending on the application, non-expansion bearings may be appropriate. An example of such a bearing is a model UCP 210-30 bearing also from AMI Bearings.

Fan shaft 45 includes structure permitting ambient air to flow through fan shaft 45 thereby limiting heat transfer through fan shaft 45 and into bearings 75, 77 and other fan components. Such structure enables fan 10 to self-cool because heat is dissipated by operation of the fan 10 itself and without any requirement for an external cooling source, such as a water cooling system or compressed air cooling system. Such structure also limits conductive heat transfer through the shaft. By limiting heat transfer into bearings 75, 77 and other fan components, the service life of such bearings and components is increased and the cost to own and operate the fan 10 and furnace 11 are decreased.

Referring again to the preferred embodiments of FIGS. 1-9, fan shaft 45 includes wall surfaces 103 defining an air-flow passageway 105, first port 107 and one or more second port 109, four of which are shown in FIGS. 1-4 and 7 (reference number 109 refers to all second ports). Put another way, at least portions of fan shaft 45 are hollow. Passageway 105 and ports 107, 109 serve as ducting permitting flow of air or other gases axially along at least portions of the fan shaft 45 proximate first bearing 75. Proximate as used herein means only that passageway 105 is sufficiently near or next to bearing 75 so as to control heat transfer from shaft 45 into such bearing 75.

Port 107 is preferably a single port located in or adjacent to fan shaft second end 51. However, port 107 may comprise plural ports. Ports 109 (or a single port) are preferably located along fan shaft outer surface 53 proximate bearing 75 as shown in FIGS. 1-4 and 7. Ports 109 should be located at a position such that they are unobstructed and free to receive or discharge air moving through passageway 105 and ports 109.

Ports 107, 109 may be located at positions other than as shown in FIGS. 1-4 and 7 provided that they permit air flow through passageway 105. For example, port 107 or plural ports could be positioned at locations along fan shaft 45 from and including second end 51 to a position or positions proximate bearing 75. Ports 109 could, for example, be located from support member 15 surface 27 to and potentially including second end 51. Ports other than ports 107, 109 could be provided.

In the example of FIGS. 1-4 and 7, port 107 is an intake port and ports 109 are discharge ports as explained herein. However, port 107 could be a discharge and ports 109 could be intakes depending on the embodiment.

As illustrated in FIGS. 1-7, preferred passageway 105 collectively comprises first portion 105a and second portions 105b and 105c. Portion 105a most preferably extends along fan shaft axis 57 from port 107 to an intersection with portions 105b, 105c. For example and as shown in FIGS. 1, 3, 4 and 6, passageway 105a most preferably extends along shaft 45 past the portion of shaft 45 supported by bearing 75 and to a position between bearing 75 and support member 15. As illustrated, portion 105a is substantially coaxial with fan shaft axis 57. Ambient air circulates through portions 105a, 105b and 105c of passageway 105 and through ports 107, 109 as the shaft rotates. This arrangement permits air flow through fan shaft 45 proximate first bearing 75 thereby controlling the temperature of fan shaft 45 proximate bearing 75 and limiting heat flow into bearing 75. Heat transfer into bearing 77 and other fan components is consequently reduced.

Other passageway 105 configurations may be acceptable. For example and while not preferred, passageway 105a could terminate near bearing 75 but between bearings 75, 77. Ports 109 and passageways 105b, 105c could then, for example, be positioned between bearings 75, 77.

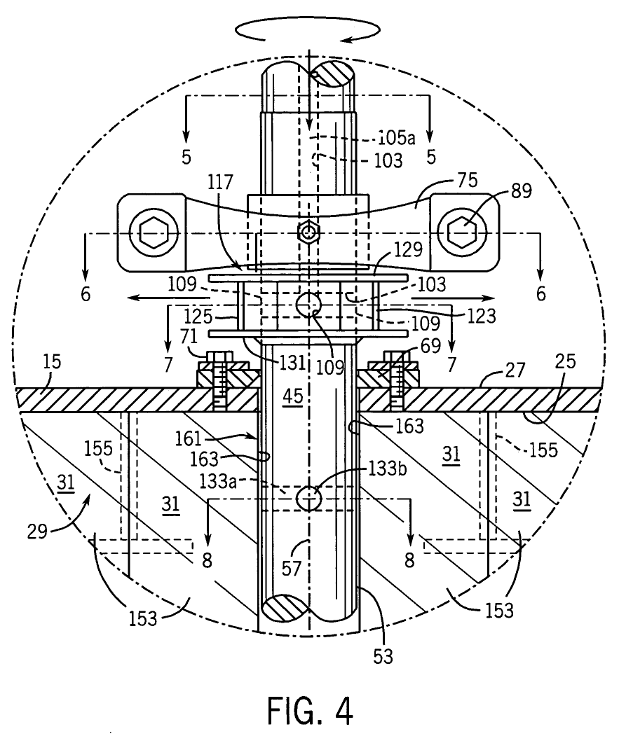

Each passageway portion 105b, 105c is preferentially positioned trans-axially entirely through fan shaft 45 and is in communication with at least one of the ports 109. In FIGS. 3-4 and 7, portions 105b, 105c extend along respective axes 111, 113. Preferably, axes 111, 113 lie in a plane such as Section 7-7 and are co-planar as indicated in FIGS. 4 and 7. It is also preferred that axes 111, 113 are transverse to the other and transverse to fan shaft axis 57. Most preferably, axes 111, 113 are normal to each other and to fan shaft axis 57. Each portion 105b, 105c preferably intersects the other and intersects portion 105a as shown in FIGS. 3-4 and 7. This arrangement advantageously removes a central region or core 115 of fan shaft 45 (FIG. 7) at the intersection of passageway portions 105b and 105c. This central region or core 115 is a highly heat conductive portion of fan shaft 45. By removing sections of fan shaft such as core 115, including core 115 along passageway 105a, the surface cross-sectional area of fan shaft 45 is reduced contributing to control of conductive heat transfer through shaft 45. And, because air in passageway 105 has low thermal conductivity relative to shaft 45, heat transfer is further limited through shaft 45.

Portions 105a, 105b and 105c can be provided in fan shaft 45 by any suitable means, such as by CNC machining, drilling and forming such openings in shaft 45 during manufacture. Portion 105a is most preferably formed by machining, drilling or cutting axially through fan shaft 45 to form a “rifle-type” bore. Portions 105b and 105c are most preferably formed by CNC machining, drilling or cutting axially across fan shaft 45 to form “cross-type” bores, as shown in the example of FIGS. 3, 4 and 7.

Portions 105a, 105b and 105c should be properly sized so that weakness at the intersection with portions 105b, 105c is not created. Depending on the sizes and types of materials used for fan shaft 45, a representative diameter of portion 105a would generally be in the range of about 0.25 to about 0.5 of fan shaft diameter 55. Portions 105a, 105b, 105c are not limited to any particular diameter or volume provided that sufficient air can circulate therein to remove sufficient heat to avoid failure of fan 10.

Other arrangements and configurations of passageway 105 are suitable within the scope of the invention. For example, plural portions could be provided in place of single portion 105a. One portion could be used in place of portions 105b, 105c (for example portion 105b only) or three or more portions could be substituted for sections 105b, 105c depending on the material selected for use in manufacture of fan shaft 45 and the diameter of such shaft. Portions 105b, 105c need not be positioned entirely through fan shaft 45. Further, each portion 105b, 105c need not be positioned normal to fan shaft axis 57.

Movement of air through passageway 105 is induced by induction apparatus 117. Referring to FIGS. 1-4, 7 and 9, induction apparatus 117 comprises a fan, or blower, assembly located proximate ports 109. Induction apparatus 117 is mounted on fan shaft 45 such that apparatus 117 co-rotates with fan shaft 45. Induction apparatus 117 induces ambient air flow through passageway 105 during fan shaft 45 rotation. As illustrated, induction apparatus 117 decreases pressure proximate ports 109 to induce air flow into port 107, through passageway 105 (and portions 105a, 105b, 105c) and out of ports 109 in the directions of arrows 119 (all arrows are identified by reference number 119). The pressure drop occurs during fan shaft 45 rotation and without a requirement for separate cooling apparatus such as water or compressed air cooling apparatus.

As shown, the fan assembly embodiment of induction apparatus 117 includes paddles 121, 123, 125, 127 extending radially outward from fan shaft 45 proximate second ports 109. Paddles 121-127 need not be in direct contact with fan shaft 45 and may be supported by spaced apart members 129, 131 having opening 118 for receiving fan shaft 45. Members 129, 131 may be welded to shaft 45 or held in place by any other suitable means. Preferably, paddles 121-127 extend radially outward from fan shaft 45 adjacent each of the second ports 109. Paddles 121-127 may be generally planar as shown or may include a slight angle, cup or other configuration useful in facilitating ambient air flow through passageway 105. The dimensions or structure of induction apparatus 117 may be modified to provide the desired pressure decrease. Induction apparatus 117 can be configured to increase pressure adjacent ports 109 so as to induce air flow into ports 109, through passageway portions 105b, 105c and 105a and out of port 107. Paddles 121-127 and members 129, 131 may be made of materials such as aluminum, number 330 stainless steel or number 304, 310, 600 or 333 nickel alloys.

An advantage of the particular arrangement of fan shaft 45, passageway 105 and induction apparatus 117 shown is that the source of ambient air is proximate port 107, a location away from furnace 11 rather than directly along furnace wall 35. Such ambient air is typically cooler than air along the furnace wall 35 thereby providing more effective heat dissipation or cooling of fan shaft 45, bearings 75, 77 and other heat-sensitive fan 10 components. In the particular embodiment shown, the fan assembly embodiment of induction apparatus 117 including members 129, 131 also acts as a radiant heat shield for lower bearing 75 providing protection for lower bearing 75 in the event of a failure of compression seal ring and packing material 71 resulting in escape of high-temperature atmosphere from furnace 11.

Referring to FIGS. 2-4 and 8, fan shaft 45 may include further structure provided to limit heat transfer through and along fan shaft 45 and into bearings 75, 77. Such structure may comprise openings or void spaces 133a, 133b. Openings 133a, 133b are most preferentially located along fan shaft 45 at a position between bearing 75 and first end spaced apart from passageways 105b, 105c and may, for example, be located proximate thermal barrier material 31.

Referring further to FIGS. 2-4 and 8, two openings or void spaces 133a, 133b are preferably provided in fan shaft 45. Each opening 133a, 133b is preferentially positioned trans-axially entirely through fan shaft 45 along an axis 135, 137. Opening 133a, 133b axes 135, 137 are most preferably co-planar as illustrated in FIGS. 4 and 8. It is also preferred that each axis 135, 137 is transverse to the other and to the fan shaft axis 57. Axes 135, 137 may be normal to each other and to axis 57. Each opening 133a, 133b is preferably formed by CNC machining, drilling or cutting axially across fan shaft 45 to form “cross-type” bores, as shown in the example of FIGS. 3, 4 and 8. This arrangement removes a further central region or core 139, again a highly heat conductive portion of fan shaft 45.

While the cross-drilled opening 133a, 133b configuration shown in FIGS. 2-4 and 8 is most highly preferred, other arrangements and configurations of openings 133a, 133b are suitable for use with shaft 45. For example, one opening, or three or more openings, could be utilized depending on the material selected for use in manufacture of fan shaft 45 and the diameter 55 of shaft 45. Each opening 133a, 133b need not be positioned entirely through fan shaft 45. Further, each opening 133a, 133b need not be positioned normal to fan shaft axis 57 and could be oriented along axes, other than those 135, 137 normal to shaft axis 57. Openings 133a, 133b could be filled with a material which is not heat conductive or has limited heat conductivity. Openings 133a, 133b are not required for operation of fan 10.

Referring next to FIGS. 1-3, fan shaft 45 is rotated by a motor 83 which is preferably an electric motor of between about 2-5 horsepower. Motor 83 may be bolted to motor mount 81. Motor 83 includes a drive shaft 143 and a pulley 145 secured thereto. Pulley 147 is secured to fan shaft 45 preferably along second end 51. Thus, in the example, second end 51 serves as a “drive end” for fan shaft 45.

Belts 149, 151 are provided to couple motor 83 to fan shaft 45 in a torque-transmitting, or power transmitting, relationship. Motor 83 may be coupled to fan shaft 45 in other manners for example, in a direct drive relationship or through a sprocket and chain linkage.

Optionally, thermal barrier material 31 may be secured within cavity 29. Thermal barrier material 31, if provided, serves both as a barrier to radiant and convective heat transfer from furnace chamber 39 to fan 10 and as a heat sink which removes heat from fan shaft 45. If thermal barrier material is not an integral part of fan 10 then it preferably is closely associated with fan 10. For example, the refractory material comprising furnace wall 35 or another associated component can provide a thermal barrier.

Optionally, thermal barrier material 31 may be secured within cavity 29. As shown in FIGS. 3 and 4, thermal barrier material 31 preferably comprises plural insulation elements 153 (each element is identified by reference number 153), each stack-bonded one to the other. The number of elements 153 will be selected based on the configuration of the particular fan 10. Stack bonding refers to compression of the insulation elements 153 by a factor of approximately 10-20%. After compression of elements 153, those elements are preferably held in place by suitable apparatus, such as anchors 155 welded to surface 25 and inserted into adjacent elements 153. This arrangement is effective at limiting heat and gas loss from furnace 11 and between elements 153. The thickness of the stack bonded elements 153 will vary depending on the particular furnace 11 wall 35 structure for which fan 10 is intended; a thickness of about 8-12 inches is preferred.

Representative materials which may be used as elements 153 are Durablanket S™ available from Unifrax Corporation of Niagra Falls, N.Y. and CER-WOOL® brand Premier High Purity, eight pound density spun fiber ceramic fiber blanket available from Premier, Inc. of King of Prussia, Pa.

An opening 161 may be cut through thermal barrier material 31 or the material comprising elements 153 may be packed around shaft 45. Thermal barrier material 31 preferably has surfaces 163 in direct contact with fan shaft outer surface 53. The close contact between surfaces 163 and shaft outer surface 53 limits heat transfer along fan shaft 45 to support member 15 and compression seal ring 69. The preferred Durablanket S or CER-WOOL materials have excellent wear resistance properties and can remain in direct contact with fan shaft outer surface 53 irrespective of rotation of fan shaft 45.

Thermal barrier material 31 such as described with its shaft-abutting surfaces 163 limits convective heat transfer along fan shaft 45 and through fan 10 to bearings 75, 77. Thermal barrier material 31 reflects radiant heat back into furnace chamber 39. Moreover, thermal barrier material 31 further serves as a heat sink drawing heat from fan shaft 45 because of the difference in temperature between the thermally conductive fan shaft 45 and adjacent thermal barrier material 31. Heat energy is discharged from the thermal barrier material to the ambient air.

Thermal barrier material 31 may comprise materials other than stack-bonded elements 153. For example, insulating bricks could be used in place of elements 153. By way of further example, a laminate formed of vacuum formed ceramic fiber board could be used in place of insulating elements 153.

As noted elsewhere, thermal barrier material 31 may be omitted. For example, frame 13 could omit walls 17-21 (and the fourth wall) enabling support member 15 to be bolted to wall 35 with fan shaft 45 extending through an opening in refractory material comprising wall 35 of furnace.

As shown in FIG. 3, thermal barrier material 31 may optionally include a further barrier layer 165 applied along insulation elements 153 facing furnace chamber 39. A material suitable for use as barrier layer 165 is Top Coat M brand coating available from Unifrax Corporation. Top Coat M is mixed in water and is sprayed onto the edge surfaces of insulation elements 153 once such insulation elements have been positioned with respect to frame 13. The material comprising layer 165 is preferably applied in a sufficient amount to have a thickness, when dried, of approximately 0.035 to 0.063 inches. Top Coat M is a desirable material for use as barrier layer 165 because such material resists atmospheric wear and degradation caused by gases within the furnace. Top Coat M also has low gas permeability thereby preventing gases from inside the furnace from passing through the thermal barrier material 31 and has excellent emisivity properties meaning that such coating radiates heat energy back into the furnace thereby further limiting heat transfer into fan 10.

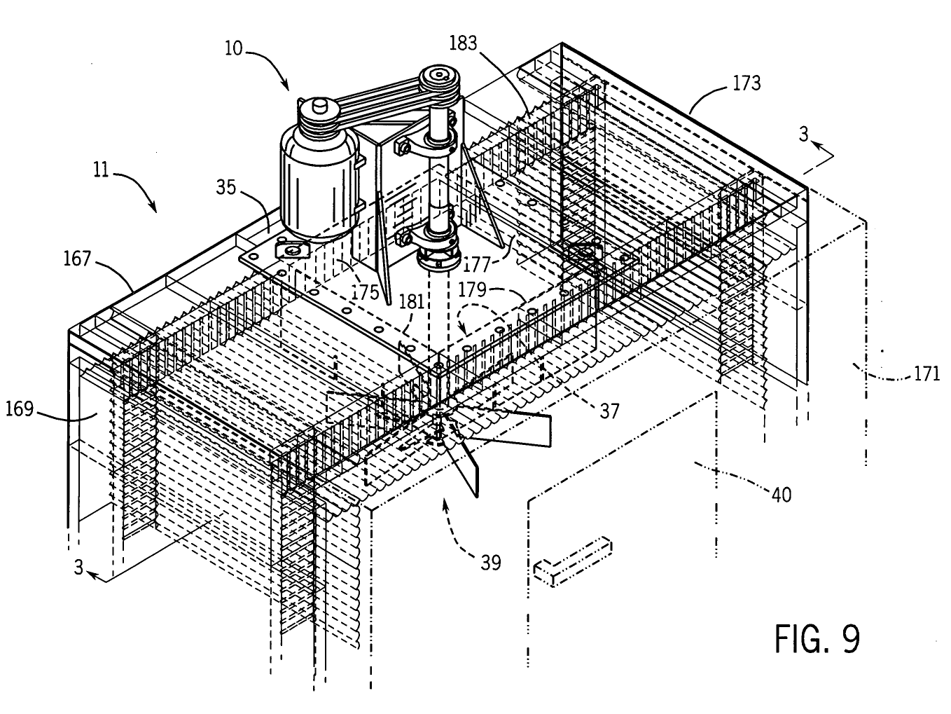

Fan 10 may be used in a heat treating furnace 11, an example of which is shown schematically in FIG. 9. Walls 35 and side walls 167, 169, 171, 173 and bottom wall (not shown) define furnace chamber 39. Door 40 is provided in one or more walls 167-173 to permit access to chamber 39. Opening 37, defined by walls 175, 177, 179, 181 is provided in furnace wall 35 for receiving fan 10.

FIG. 3 is a side sectional view of wall 35 and side elevation view of fan 10 inserted into wall opening 37. It is preferred that frame 13 is sized and shaped to conform to opening 37 with side walls 17-21 (and the fourth frame 13 wall) sized to closely abut opening walls 175-181 to prevent loss of heat energy and gases from furnace chamber 39. Fan shaft 45 is sized so that fan element 47, is positioned within furnace chamber 39. Rotation of fan element 47 causes an even distribution of temperature and gases within furnace chamber 39.

Fan 10 may be mounted to furnace wall surfaces other than wall 35 shown in FIGS. 3 and 9. For example, fan 10 could be mounted to side wall 171 such that fan shaft 45 extends along a generally horizontal axis. And, fan 10 could be mounted to a furnace wall 35 exterior surface 183 with appropriate mounting hardware instead of being inserted into a wall opening, such as opening 37. In such an embodiment, fan shaft 45 would be sized for insertion through wall 35 so that fan element 47 is supported in furnace chamber 39.

It is also possible that fan 10 can be mounted along other structure positioned with respect to furnace 11 so that fan 10 is in position to displace gases within the furnace chamber or chamber 39. For example, fan 10 could be mounted in what is known to persons of skill in the art as a “burner box.” The burner box includes walls defining a burner box chamber and the burner box is attached along a furnace wall, such as wall 171 in FIG. 9. One or more ducts are provided to form a gas passageway between the furnace chamber 39 and the burner box chamber.

Fan 10 could be positioned in a burner box wall as described above with respect to wall 171. Rotation of fan element 67 within the burner box chamber draws gas from furnace chamber 39 through the duct or ducts, into the burner box chamber, out through the duct or ducts and back into the furnace chamber. While the fan element (such as element 47) is not directly in the furnace chamber or chamber (such as chamber 39), the movement of element 47 displaces gases within the furnace chamber and provides an evenly distributed atmosphere within the furnace. Fan 10 may be mounted in other positions and arrangements to displace high-temperature gas, for example, within a chamber formed by a pipe.

It is to be understood that Fan 10 may be configured and designed to operate with devices other than furnace 11 and under temperature conditions which are either greater or lesser than those discussed in connection with the example. Fan 10 may be supplied as a complete or partially complete unit and fan shafts 45 can be provided separately.

While the principles of this invention have been described in connection with specific embodiments, it should be understood clearly that these descriptions are made only by way of example and are not intended to limit the scope of the invention.

What is claimed is:

1. A self-cooled high-temperature fan apparatus for circulating high-temperature gas within a chamber comprising:
a frame;
a bearing secured with respect to the frame;
a fan shaft rotatably supported by the bearing, the fan shaft having first and second ends and an axis therebetween, the fan shaft defining: (1) an air-flow passageway therein at least a portion of which extends within the shaft along the axis proximate the bearing and (2) air-flow ports in communication with the passageway;
induction apparatus mounted on the fan shaft proximate at least one of the ports such that co-rotation of the fan shaft and induction apparatus induces air to flow through the passageway; and
a fan element secured proximate the fan shaft first end.

2. The high-temperature fan apparatus of claim 1, wherein the ports comprise:
a first port located at a position between the bearing to and including the fan shaft second end; and
a plurality of second ports located in the fan shaft between a position proximate the bearing and the fan shaft first end such that air is permitted to flow therethrough.

3. The high-temperature fan apparatus of claim 2, wherein the passageway comprises:
a first portion in communication with the first port and extending axially along at least a portion of the shaft proximate the bearing; and
at least one second portion intersecting the first portion, each second portion being in communication with at least one of the second ports.

4. The high-temperature fan apparatus of claim 3, wherein the at least one second portion comprises plural second portions each having an axis transverse to the fan shaft axis.

5. The high-temperature fan apparatus of claim 4, wherein each second portion axis is co-planar.

6. The high-temperature fan apparatus of claim 3, wherein the first portion is coaxial with the fan shaft axis.

7. The high-temperature fan apparatus of claim 3, wherein the first and second portions are bores in the fan shaft.

8. The high-temperature fan apparatus of claim 3, wherein the induction apparatus is mounted proximate the plurality of second ports.

9. The high-temperature fan apparatus of claim 8, wherein the induction apparatus comprises a fan assembly.

10. The high-temperature fan apparatus of claim 9, wherein the fan assembly comprises a plurality of paddles extending radially outward from the fan shaft.

11. The high-temperature fan apparatus of claim 10, wherein each paddle is substantially planar.

12. The high-temperature fan apparatus of claim 3, wherein the fan shaft further defines at least one void space extending at least partially through the fan shaft at a location between the second ports and fan shaft first end.

13. The high-temperature fan apparatus of claim 3, wherein the bearing is a first bearing and the fan further comprises:
a second bearing secured with respect to the frame rotatably supporting the fan shaft between the first bearing and fan shaft second end; and
a motor secured with respect to the frame in power-transmission relationship with the fan shaft.

14. The high-temperature fan apparatus of claim 13, wherein the fan shaft has a diameter and a surface defining an opening proximate the first bearing and the first bearing comprises:
an inner race positioned about the fan shaft, said inner race having an inside diameter greater than the fan shaft diameter when cool;
an outer race positioned about the inner race;
bearings positioned between the inner and outer races; and
a pin projecting radially inwardly from the inner race and into the fan shaft surface opening;
wherein the fan shaft and inner race co-rotate when the fan shaft is powered for rotation and the inner race accommodates thermal expansion of the fan shaft.

15. The high-temperature fan apparatus of claim 3, wherein the fan element is selected from the group consisting of a radial fan, an axial fan and a centrifugal fan.

16. The high-temperature fan apparatus of claim 3, further comprising thermal barrier material secured with respect to the frame.

17. The high-temperature fan apparatus of claim 16, wherein the thermal barrier material comprises plural insulation elements, each arranged one after the other so that adjacent elements are in abutting relationship.

18. A self-cooled high-temperature fan apparatus for circulating high-temperature gas within a chamber comprising:
a frame;
a bearing secured with respect to the frame;
a fan shaft rotatably supported by the bearing, the fan shaft having first and second ends and an axis therebetween, the fan shaft defining air-flow ports and an air-flow passageway in communication with the ports, the passageway having a first portion which extends within the fan shaft substantially along the axis proximate the bearing and at least one second portion intersecting the first portion;
induction apparatus mounted on the fan shaft proximate at least one of the ports such that co-rotation of the fan shaft and induction apparatus induces air to flow through the passageway; and
a fan element secured proximate the fan shaft first end for circulating high-temperature gas within the chamber.

19. The high-temperature fan apparatus of claim 18, wherein the ports comprise:
a first port located at a position between the bearing to and including the fan shaft second end in communication with the passageway first portion; and
a plurality of second ports in communication with the at least one second portion, the second ports being located between a position proximate the bearing and the fan shaft first end such that air is permitted to flow therethrough.

20. The high-temperature fan apparatus of claim 19, wherein the at least one second portion comprises plural second portions each extending along an axis transverse to the fan shaft axis.

21. The high-temperature fan apparatus of claim 19, wherein the first portion is substantially coaxial with the fan shaft axis and extends from the fan shaft second end to a position between the bearing and fan shaft first end.

22. The high-temperature fan apparatus of claim 19, wherein the induction apparatus is mounted proximate the plurality of second ports.

23. The high-temperature fan apparatus of claim 22, wherein the induction apparatus comprises a fan assembly.

24. The high-temperature fan apparatus of claim 23, wherein the fan assembly comprises a plurality of paddles extending radially outward from the fan shaft.

25. The high-temperature fan apparatus of claim 24, wherein the paddles induce air flow into the first port during fan rotation.

26. The high-temperature fan apparatus of claim 19, wherein the fan shaft further defines at least one void space extending at least partially through the fan shaft at a location between the second ports and fan shaft first end.

27. The high-temperature fan apparatus of claim 19, wherein the bearing is a first bearing and the fan further comprises:
a second bearing secured with respect to the frame rotatably supporting the fan shaft between the first bearing and fan shaft second end; and
a motor secured with respect to the frame in power-transmission relationship with the fan shaft.

28. The high-temperature fan apparatus of claim 19, wherein the fan shaft has a diameter and a surface defining an opening proximate the first bearing and the first bearing comprises:
an inner race positioned about the fan shaft, said inner race having an inside diameter greater than the fan shaft diameter when cool;
an outer race positioned about the inner race;
bearings positioned between the inner and outer races; and
a pin projecting radially inwardly from the inner race and into the fan shaft surface opening;
wherein the fan shaft and inner race co-rotate when the fan shaft is powered for rotation and the inner race accommodates thermal expansion of the fan shaft.

29. The high-temperature fan apparatus of claim 19, wherein the fan element is selected from the group consisting of a radial fan, an axial fan and a centrifugal fan.

30. The high-temperature fan apparatus of claim 19, further comprising thermal barrier material secured with respect to the frame.

31. A self-cooled fan shaft for use in a high-temperature fan apparatus comprising:
a fan shaft having first and second ends and an axis therebetween;
at least one fan shaft wall defining an air-flow passageway at least a portion of which extends within the shaft substantially along the axis proximate an attachment point for a rotatable support and further defining air-flow ports in communication with the passageway; and
induction apparatus mounted on the fan shaft proximate at least one of the ports such that co-rotation of the fan shaft and induction apparatus induces air to flow through the passageway.

32. The fan shaft of claim 31, wherein the ports comprise:
a first port located proximate the fan shaft second end; and
a plurality of second ports located in the fan shaft between a position proximate the attachment point and the fan shaft first end such that air is permitted to flow therethrough.

33. The high-temperature fan apparatus of claim 32, wherein the passageway comprises:
a first portion in communication with the first port and extending axially along at least a portion of the shaft proximate the attachment point; and
at least one second portion intersecting the first portion, each second portion being in communication with at least one of the second ports.

34. The fan shaft of claim 31, further comprising at least one fan element secured proximate the fan shaft first end.

35. A self-cooled high-temperature fan apparatus assembly for circulating high-temperature gas within a chamber comprising:
a frame;
a bearing secured with respect to the frame;
a fan shaft for supporting a fan element, the fan shaft being rotatably supported by the bearing and having first and second ends and an axis therebetween, the fan shaft further defining an air-flow passageway therein at least a portion of which extends within the shaft along the axis proximate the bearing and air-flow ports in communication with the passageway; and
induction apparatus mounted on the fan shaft proximate at least one of the ports such that co-rotation of the fan shaft and induction apparatus induces air to flow through the passageway.

36. The fan apparatus assembly of claim 35, further comprising a fan element secured proximate the fan shaft first end.

37. The fan apparatus assembly of claim 35, wherein the fan element is selected from the group consisting of a radial fan, an axial fan and a centrifugal fan.
